(19) United States
(12) Patent Application Publication
(10) Pub. No.: US 2019/0173302 A1
(43) Pub. Date: Jun. 6, 2019

(54) Fluid flow detector with a detachable battery module

(71) Applicants: KERI WATERS, SANTA CRUZ, CA (US); Joel Boutros, SANTA CRUZ, CA (US)

(72) Inventors: KERI WATERS, SANTA CRUZ, CA (US); Joel Boutros, SANTA CRUZ, CA (US)

(21) Appl. No.: 15/973,360

(22) Filed: May 7, 2018

Related U.S. Application Data
(63) Continuation-in-part of application No. 15/831,271, filed on Dec. 4, 2017.
Application No. 15/831,271 is a continuation-in-part of application No. 15/904,290, filed on Feb. 23, 2018.

(51) Int. Cl. H02J 7/00; G01F 1/00; H02J 7/02; H02J 7/35

(52) U.S. Cl. CPC H02J 7/0045; G01F 1/00; H02J 7/35; H02J 7/02; H02J 7/0068

(57) ABSTRACT

A method and system for enabling detachable coupling of an electrical power storage battery includes a detachable battery module with an energy storage cell that powers a fluid flow detector, a communications interface and optionally a controller. The fluid flow detector, the communications interface and the controller are communicatively coupled. A housing encloses and protects the fluid flow detector, the communications interface and the controller and provides a receiver structure that accepts and at least partially encloses the battery module. An external power source provides electrical power source wherein a pathway of the module enables electrical energy delivery to the energy storage cell, the fluid flow detector, the communications interface and the controller. The battery module comprises at least one keyed feature to permit only properly aligned detachable coupling of the detachable battery with the controller.

### CO-PENDING APPLICATIONS

The present Nonprovisional patent application is a Continuation-in-Part Nonprovisional patent application to, and claims the priority date of, U.S. Nonprovisional patent application Ser. No. 15/831,271 filed on Dec. 4, 2017 and titled “Fluid flow detector with tethered drag block”. U.S. Nonprovisional patent application Ser. No. 15/831,271 is hereby incorporated by reference in its entirety and for all purposes into the present Nonprovisional patent application.

The present Nonprovisional patent Application is also a Continuation-in-Part Nonprovisional patent application to, and claims the priority date of, U.S. Nonprovisional patent application Ser. No. 15/904,290 filed on Feb. 23, 2018 and titled “INVENTED SYSTEM AND METHOD FOR ANALYZING AND MANAGING FLUID FLOW”. U.S. Nonprovisional patent application Ser. No. 15/904,290 is hereby incorporated by reference in its entirety and for all purposes into the present Nonprovisional patent application.

### FIELD OF THE INVENTION

The present invention is in the field of fluid management, flow rate measurement, and leak detection, including but not limited to fluids consisting of or comprising water.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

Fluid flow monitoring devices are being increasingly deployed in new building construction and installed by retrofitting into plumbing systems and chemical delivery and processing systems. Motivations for the design, production and implementation of prior art fluid flow monitoring devices include both addressing a growing cultural emphasis in conserving water and achieving financial gains by reducing wastage of water and/or other chemical fluid resources.

Prior art fluid flow monitoring devices are often configured with at least one electrical power storage battery (hereinafter, “battery”) as a primary energy source or as a back-up source of electrical energy for components of these systems. It is not unusual for a prior art design to include a rechargeable battery that is charging from an external electrical power source while the device is drawing power from that external source. The stored energy of rechargeable battery is typically drawn upon when there is a failure of the external power source.

These widely deployed monitoring systems of differing configurations and characteristics are sometimes positioned in hard to access locations, and sometimes placed in locations visible to building occupants and site visitors. Various prior art fluid flow device products present different challenges and requirements in operation and system maintenance. Yet the relevant experience levels and sophistication of persons tasked with, and in some cases unexpectedly required to, perform maintenance actions or respond to external power outages varies widely. As a device manufacturer generally seeks to achieve maximum market acceptance, it is generally thus preferable in general that equipment maintenance of fluid flow monitoring devices by easily performed by persons having minimal experience and little knowledge in equipment maintenance.

Commercially available electrical power storage batteries have finite energy storage capacities and generally degrade in performance over a life cycle. Yet the prior art fails to optimally simplify battery replacement tasks of fluid flow monitoring devices nor provide modular designs that reduce the skill and experience levels required by a device operator to swap out and replace a fluid flow monitoring device battery.

There is thus a long felt need for modular fluid flow monitoring products that enable reductions in interruptions in electrical power access, simplify in situ battery replacement actions, provide battery protection from environmental damage, increase confidence in intended use by potential device purchasers having various levels of equipment maintenance competence, and offer more intuitive coupling and decoupling of pluralities of batteries within a same device.

### OBJECTS OF THE INVENTION

It is an object of the present invention to provide a fluid flow monitoring device that includes a replaceable electrical storage battery.

It is an optional object of the present invention to provide a fluid flow device that provides a system design that presents a more intuitive indication of how to swap out a replaceable electrical storage battery.

It is another optional object of the present invention to provide a fluid flow device that reduces the time and skill level required to confidently identify and replace an electrical storage battery of a fluid flow monitoring device.

It is yet another optional object of the present invention to provide a battery powered fluid flow monitoring device that presents an aesthetic appearance that increases the confidence level of the public, potential purchasers, and device operators regarding reliability expectations and maintenance requirements thereof.

It is a still other optional object of the present invention to provide a fluid flow device that exhibits a keyed design that increases the ease and reduces error rates in swapping out replacement batteries.

### SUMMARY OF THE INVENTION

Towards these and other objects of the method of the present invention (hereinafter, “the invented method”) that are made obvious to one of ordinary skill in the art in light of the present disclosure, the present invention provides a fluid flow monitoring system (hereinafter, “the invented system”) having a detachable and replaceable electrical energy storage element. The method of the present invention (hereinafter, “the invented method”) enables monitoring and optionally means to affect water flow within an element of a plumbing structure.

A first preferred embodiment of the invented system includes a fluid flow detector coupled with a fluid channel and sensing fluid flow of the channel and optionally generating measurement data, a communications interface communicatively coupled with the flow detector and receiving measurement data from the flow detector and an optional controller, and a detachable battery removably connected with the flow detector and the communications interface, the detachable battery providing electrical power to the flow detector and the communications interface and optionally the controller.

An alternate preferred embodiment of the invented system additionally includes a housing that at least partially encloses the fluid flow detector, the communications interface, the optional controller and the battery. An external power source link enables delivery of electrical energy from an external source to the fluid flow detector, the communications interface, the optional controller and the detachable battery.

An optional power pathway selectively enables the detachable battery to deliver power to the fluid flow detector, the communications interface, and the optional controller.

Another alternate preferred embodiment of the invented system alternatively and/or additionally includes one or more keyed features that inhibit attempts to improperly align the detachable battery with the housing and/or the controller. At least one keyed feature includes an electrical power connector. Optionally, that keyed feature or another keyed feature permits only properly aligned detachable placement of the detachable battery with the housing and/or electrical power connectivity with the controller.

Another even alternate preferred embodiment of the invented system alternatively and/or additionally includes a shaped sealant structure that at least partially encompasses the battery and permits only properly aligned detachable placement of the detachable battery with the housing. Additionally or alternately, the battery is shaped or configured with at least one alternate keyed feature, for example but not limited to an electrical power connector, that enables only properly aligned detachable placement of the detachable battery with the housing.

An alternate preferred embodiment of the housing comprises a recessed portion and a shaped sealant structure of the battery comprises projection that in combination permit only properly aligned detachable placement of the detachable battery with the housing.

An alternate preferred embodiment of the fluid flow detector indicates when fluid flow in the fluid flow channel exceeds a fluid flow threshold value and/or a measured value of fluid flow of the fluid flow channel.

Another yet other preferred embodiment of the invented system provides a battery module comprising an energy storage cell coupled with a power management circuit, wherein the power management circuit is configured to receive and manage distribution of electrical power received from (1.) a mains power network, (2.) a solar power generator; and/or (3.) an in-pipe electrical power generation module.

Another still alternate preferred embodiment of the invented system includes a means to detect fluid flow through a channel, a means to report fluid flow detection, and a manually portable electrical power source detachably coupled with the means to detect and the means to report, the detachable battery providing electrical power to the means to detect fluid and the means to report.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE FIGURES

The detailed description of some embodiments of the invention is made below with reference to the accompanying figures, wherein like numerals represent corresponding parts of the figures.

FIG. 1A is an illustration of a typical prior art fluid flow detection system electrically coupled with and receiving electrical power from an external power source;

FIG. 1B is an illustration of a typical prior art fluid flow detection system having an integrated electrical power battery;

FIG. 2A is a block diagram of a preferred embodiment of the present invention comprising a housing and an invented externally accessible and detachable battery module;

FIG. 2B is a detailed block diagram of control and sensory aspects of the preferred embodiment of the present invention of FIG. 2A;

FIG. 2C is a detailed block diagram of the invented externally accessible and detachable battery module of FIG. 2A;

FIG. 3A is a perspective back view of the invented battery of FIG. 2A with optional keyed features;

FIG. 3B is a detailed top view of the invented battery of FIG. 2A with optional keyed features;

FIG. 3C is a detailed front plan view of the invented battery of FIG. 2A with optional keyed features;

FIG. 3D is a detailed right side plan view of the invented battery of FIG. 2A with optional keyed features;

FIG. 4 is a cut away perspective top view of the invented battery of FIG. 2A inserted into a receiver of a housing of FIG. 2A and the receiver presenting keyed housing features matching the optional keyed battery features;

FIG. 5A is a detailed top view of the housing receiver of FIG. 4 showing the housing keyed features that match the battery keyed features of FIG. 3A;

FIG. 5B is a detailed front plan view of the housing receiver of FIG. 4 showing the housing keyed features that match the battery keyed features of FIG. 3B;

FIG. 5C is a detailed perspective front view of the housing receiver of FIG. 4 showing the housing keyed features that match the battery keyed features of FIG. 3C;

FIG. 6 is a block diagram of an alternate preferred embodiment of the detachable battery module of FIG. 2A that includes a power management circuit configured to receive electrical power directly through an external connector and manage distribution of electrical power received from a standard mains power network;

FIG. 7A is a block diagram of another alternate preferred embodiment of the detachable battery module of FIG. 6 that includes a power management circuit configured to manage distribution of electrical power received from a solar energy generator module;

FIG. 7B is a block diagram of a third alternate preferred embodiment of the detachable battery module of FIG. 2A includes a power management circuit configured to manage distribution of electrical power received from a solar energy generator module as received directly through an external connector;

FIG. 8A is a block diagram of a still alternate preferred embodiment of the present invention comprising a housing and a yet alternate preferred embodiment of the invented battery module, wherein the alternate preferred embodiment of the present invention is adapted to receive power from an in-pipe hydro-power generator module;

FIG. 8B is a block diagram of the still alternate preferred embodiment of the invented battery module of FIG. 8A that includes a power management circuit configured to manage distribution of electrical power received directly via an external connector from the in-pipe hydro-power generator module of FIG. 8A; and

FIG. 8C is a block diagram of an additional alternate preferred embodiment of the invented battery module of FIG. 8A that includes a power management circuit configured to manage distribution of electrical power received with reduced intermediation from the in-pipe hydro-power generator module of FIG. 8A.

### DETAILED DESCRIPTION

In the following detailed description of the invention, numerous details, examples, and embodiments of the invention are described. However, it will be clear and apparent to one skilled in the art that the invention is not limited to the embodiments set forth and that the invention can be adapted for any of several applications.

It is to be understood that this invention is not limited to particular aspects of the present invention described, as such may, of course, vary. It is also to be understood that the terminology used herein is for the purpose of describing particular aspects only, and is not intended to be limiting, since the scope of the present invention will be limited only by the appended claims. Methods recited herein may be carried out in any order of the recited events which is logically possible, as well as the recited order of events.

Where a range of values is provided herein, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the limits ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, the methods and materials are now described.

It must be noted that as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

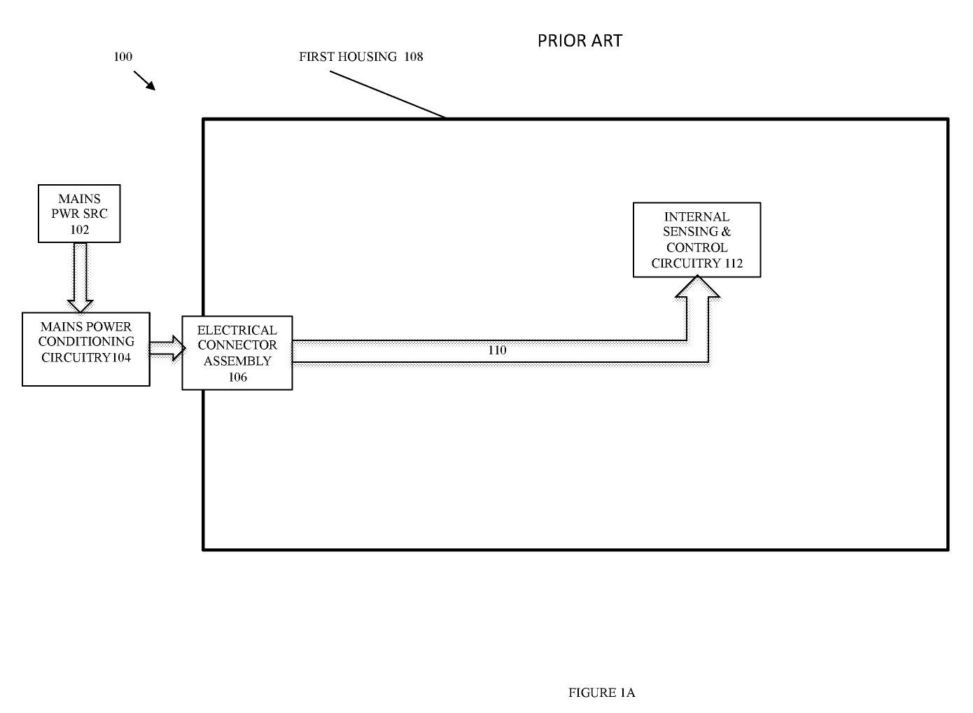

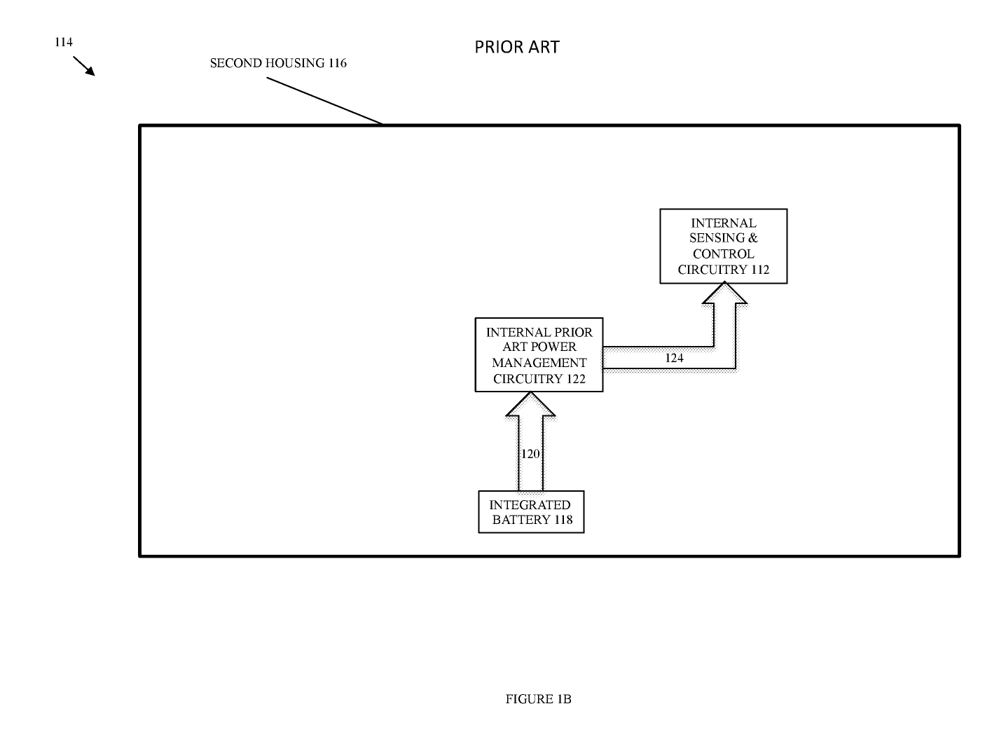

Referring now generally to the Figures and particularly to FIG. 1A, FIG. 1A is an illustration of a first prior art fluid flow detection system 100 electrically coupled with and receiving electrical power from an external mains power source 102 via an intermediating mains power conditioning circuitry 104. The first prior art fluid flow detection system 100 includes a prior art electrical connector assembly 106 that is coupled with and extends through a first prior art housing 108. The prior art electrical connector assembly 106 is electrically coupled with a prior art power bus 110. The prior art power bus 110 is additionally coupled with a prior art internal sensing and control circuitry 112, wherein the prior art power bus 110 is configured to provide electrical power received from the prior art electrical connector assembly 106. It is understood that the prior art internal sensing and control circuitry 112 is adapted and configured to monitor and report fluid flow measurements.

Referring now generally to the Figures and particularly to FIG. 1B, FIG. 1B is an illustration of a typical prior art fluid flow detection system 114 having a second prior art housing 116 coupled with and substantively enclosing an integrated electrical power battery 118. A first internal power bus 120 delivers electrical power received from the integrated electrical power battery 118 to an internal prior art power management circuitry 122. A second internal power bus 124 delivers electrical power received from the internal prior art power management circuitry 122 to the prior art internal sensing and control circuitry 112.

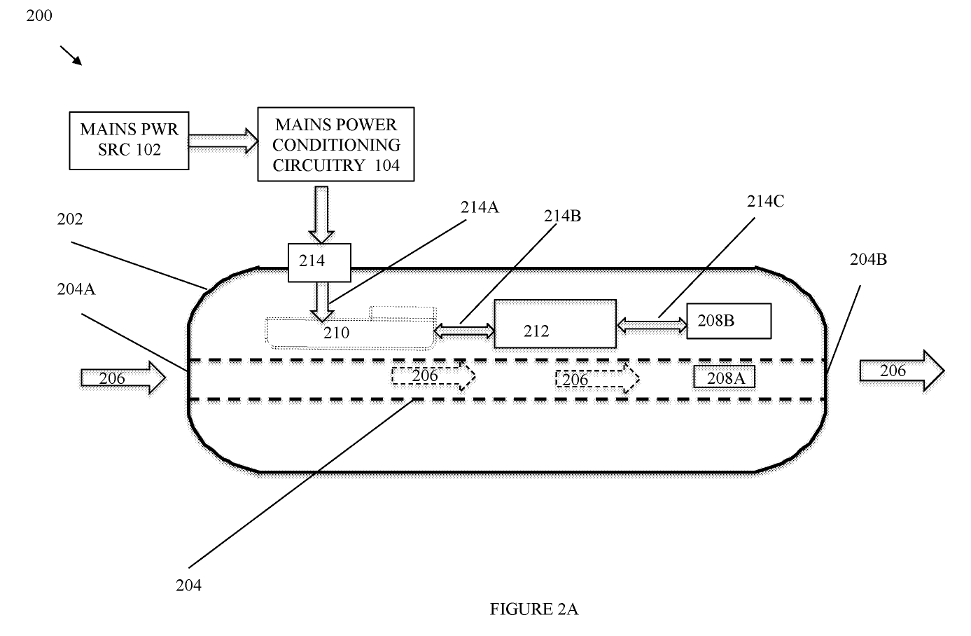

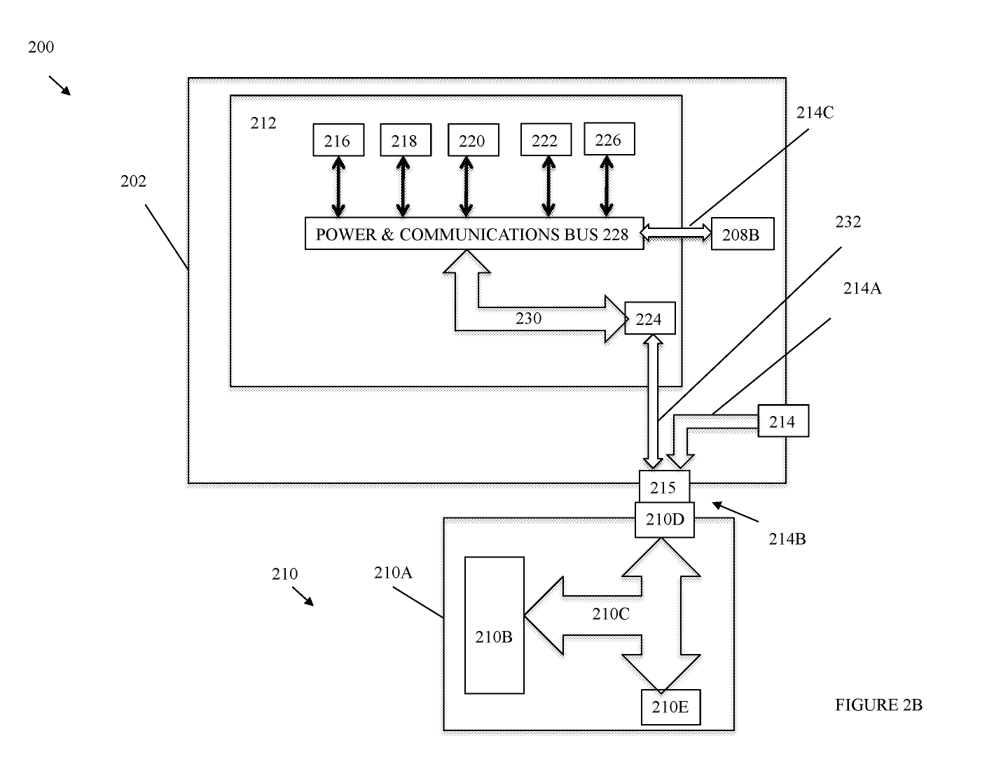

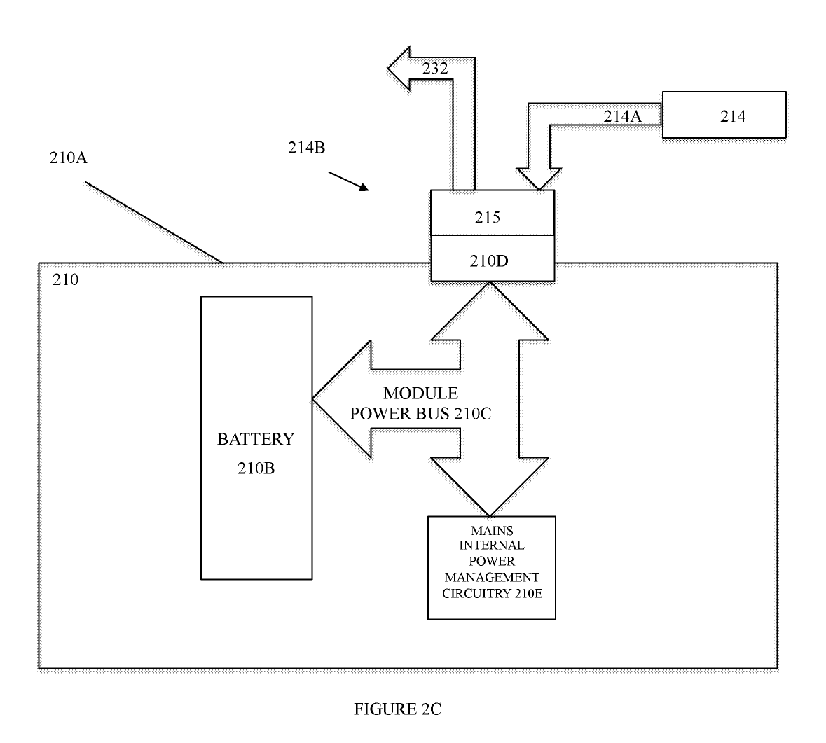

Referring now generally to the Figures and particularly to FIG. 2A, FIG. 2A is a block diagram of a first preferred embodiment of the present invention 200 (hereinafter, “the first invented system” 200) comprising a thermoplastic housing 202 forming a fluid channel 204 through which a fluid 206 traverses fully through and exits the housing 204. Flow of the fluid 206 into and out the housing 202 is enabled and not impeded by either a first channel aperture 204A or a second channel aperture 204B that are comprised within and define fluid access locations of the fluid channel 204. A fluid flow sensor 208A is coupled to the housing 202 and resides within the channel 204. A sensor signal receiver 208B is substantively enclosed within the housing 202 and is preferably adapted to wirelessly receive electrical or magnetic signals related to flow rates of the fluid 206 as generated by the fluid flow sensor 208A. It is understood that the fluid 206 may be or comprise water in its liquid state.

A first preferred embodiment of the invented detachable battery module 210 (hereinafter, “the first battery module” 210) is removably mechanically coupled with the housing 202 and detachably electrically coupled with a control module 212. The first battery module 210 is detachably coupled with an external system connector 214 that is in turn mechanically coupled with and extends through the housing 202. A first power bus 214A carries electrical power received from the external system connector 214 and toward the first battery module 210. A connector assembly 214B delivers electrical power as managed by the first battery module 210 from the first battery module 210 and to the control module 212. A power and signal bus extension 214C delivers electrical power to the sensor signal receiver 208B as controllably transferred from the control module 212. It is understood that the sensor signal receiver 208B is located within the 202 but externally from the control module 212.

The external system connector 214 is configured to receive electrical power from the mains power conditioning circuitry 104 and is preferably adapted for detachable electrical and mechanical coupling with the mains power conditioning circuitry 104. The external system connector 214 transfers electrical power received from the mains power conditioning circuitry 104 to the first battery module 210. It is understood that a common electrical ground is preferably imposed within the first invented system 200 and the first battery module 210 by inclusion of a ground wiring (not shown) or other suitable electrical grounding structures known in the art.

Referring now generally to the Figures and particularly to FIG. 2B, FIG. 2B is a detailed block diagram of control and sensory aspects of the first invented system 200. The first battery module 210 includes a thermoplastic module shell 210A that substantively encloses and is mechanically coupled with an electrical charge battery 210B (hereinafter, “the battery 210B”), a module power bus 210C, a module connector 210D and a power management circuit 210E. The thermoplastic module shell 210A is preferably shaped with keyed external features that inhibit attempting to couple the first battery module 210 with the housing 202 in orientations unintended by a designer or designers of the first invented system 200.

The connector assembly 214B comprises the module connector 210D of the first battery module 210 and the internal system connector 215 of the first invented system 200. The internal system connector 215 is mechanically coupled with and extends through the housing 202 of the first invented system 200 and is configured and adapted to be detachably electrically and mechanically coupled with the module connector 210D; the internal system connector 215 selectively transfers signals and electrical power both to and from module connector 210D. The module connector 210D extends through the module shell 210A and selectively transfers signals and electrical power both to and from the module power bus 210C, the battery 210B, the power management circuit 210E and the internal system connector 215. The module connector 210D is configured and adapted to be detachably electrically and mechanically coupled with the internal system connector 215 to enable manual forming and disassembling of the connector assembly 214B.

The control module 212 includes a BlueTooth™ transceiver 216, a WiFi™ transceiver 218, an electronic solid-state digital memory device 220, a controller 222 and a system power management module 224, a cellular telephony modem module 226, a system power and communications bus (hereinafter, “the system bus” 228), a power management power and communications bus (hereinafter, “the control bus” 230),

It is understood that the BlueTooth™ transceiver 216, the WiFi™ transceiver 218, the electronic solid-state digital memory device 220 and the cellular telephony modem module 226 are each optional elements of the first invented system 200 that are included in various combinations in diverse alternate preferred embodiments of the present invention.

The system power management module 224 receives electrical power from and bi-directionally communicates with the battery module via an intermediate power and communications bus 232; the intermediate power and communications bus 232 is electrically and bi-directionally communicatively coupled with both the system power management module 224 and the internal system connector 215. The system bus 228 is configured and adapted to thereby receive electrical power from and enable bi-directional communications to and from the first battery module 210 as directed by the system power management module 224.

The control bus 230 enables bi-directional communication between the system bus 228 and the system power management module 224; the system bus 228 further transfers electrical energy received via the system power management module 224 to the sensor signal receiver 208B via the power and signal bus extension 214C, the BlueTooth™ transceiver 216, the WiFi™ transceiver 218, the electronic solid-state digital memory device 220, the controller 222 and the cellular telephony modem module 226. The system bus 228 additionally bi-directionally communicatively couples the system power management module 224, the sensor signal receiver 208B via the power and signal bus extension 214C, the BlueTooth™ transceiver 216, the WiFi™ transceiver 218, the electronic solid-state digital memory device 220, the controller 222 and the cellular telephony modem module 226.

It is understood that the fluid flow sensor 208A may be or comprise a product number AAT001-10E™ fluid flow sensor marketed by NVE, Inc. of Eden Prairie, Minn.; that the 216 BlueTooth transceiver 216 may be or comprise a product number SAMB11™ as marketed by Microchip Technology, Inc. of Chandler, Ariz.; that the WiFi transceiver 218 may be or comprise a product number WINC1500™ as marketed by Microchip Technology, Inc. of Chandler, Ariz.; that the memory device 220 may be or comprise a suitable memory device product as marketed by Adesto Technologies of Santa Clara, Calif.; that the controller 222 may be or comprise a product number SAMD21™ as marketed by Microchip Technology, Inc. of Chandler, Ariz.; that the system power management module 224 may be or comprise a product number SC8802™ as marketed by Southchip Semiconductor Technology Corporation of China; and that the cellular telephony modem module 226 may be or comprise a Skywire™ cellular telephony modem as marketed by Nimbelink, Inc. of Plymouth, Minn.

As generally noted above, is understood that a common electrical ground is preferably shared by the buses 214A, 214C & 210C and the connectors 214, 215 & 210D by inclusion of a ground wiring (not shown) or other suitable electrical grounding structures known in the art.

Referring now generally to the Figures and particularly to FIG. 2C, FIG. 2C is a detailed block diagram of the first battery module 210. The module power bus 210C enables receipt of electrical power from the module connector 210D and delivers the received electrical power to the module power management circuitry 210E, the module battery 210B and the intermediate power and communications bus 232 via the module connector 210D as directed and rectified by the module power management circuitry 210E. The module power bus 210C optionally additionally enables bi-directional communications between the module power management circuitry 210E and the control board 212 via the intermediate power and communications bus 232 whereby battery status and battery module 210 control information can be exchanged between the module power management circuitry 210E and the control board 212 via the intermediate power and communications bus 232.

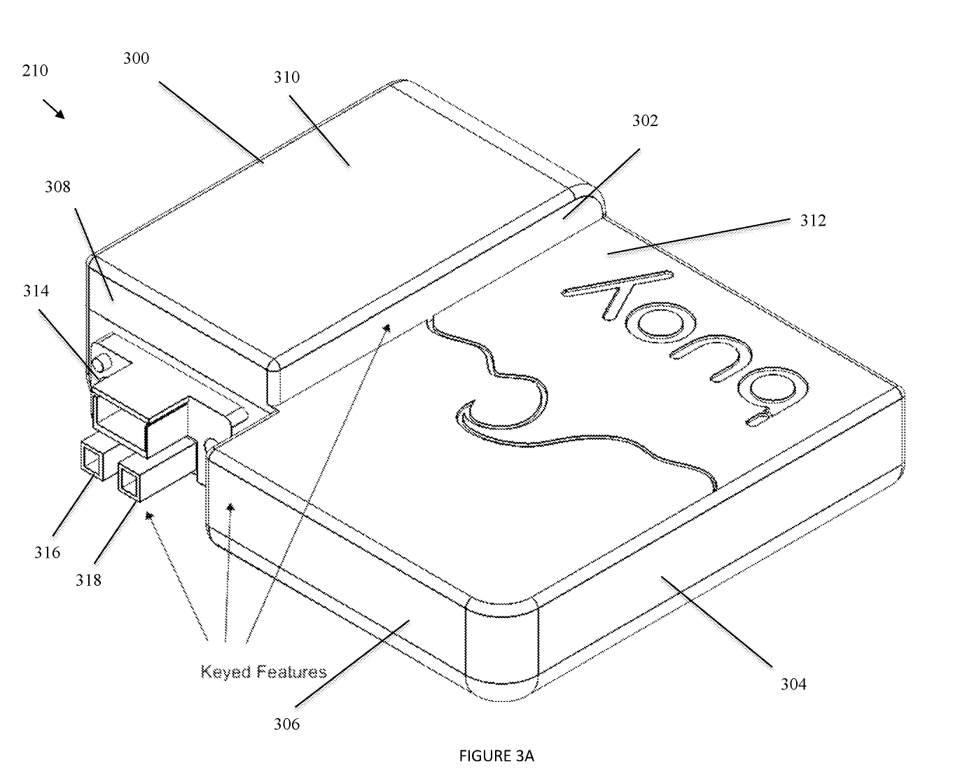

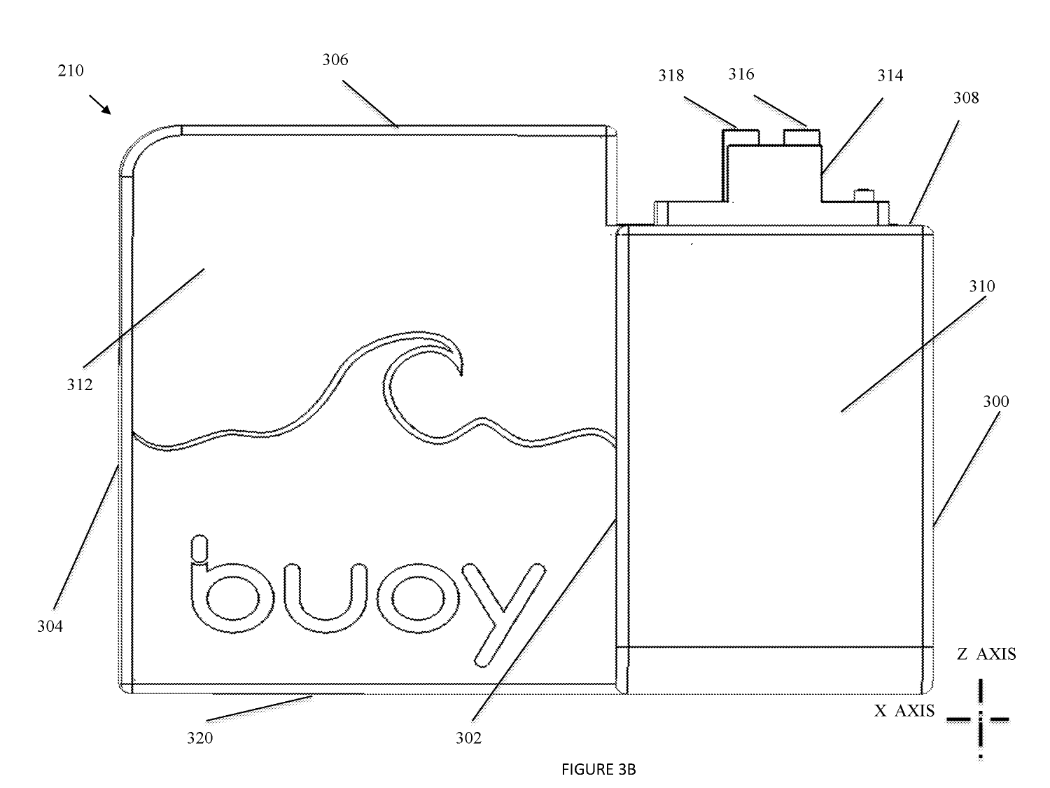

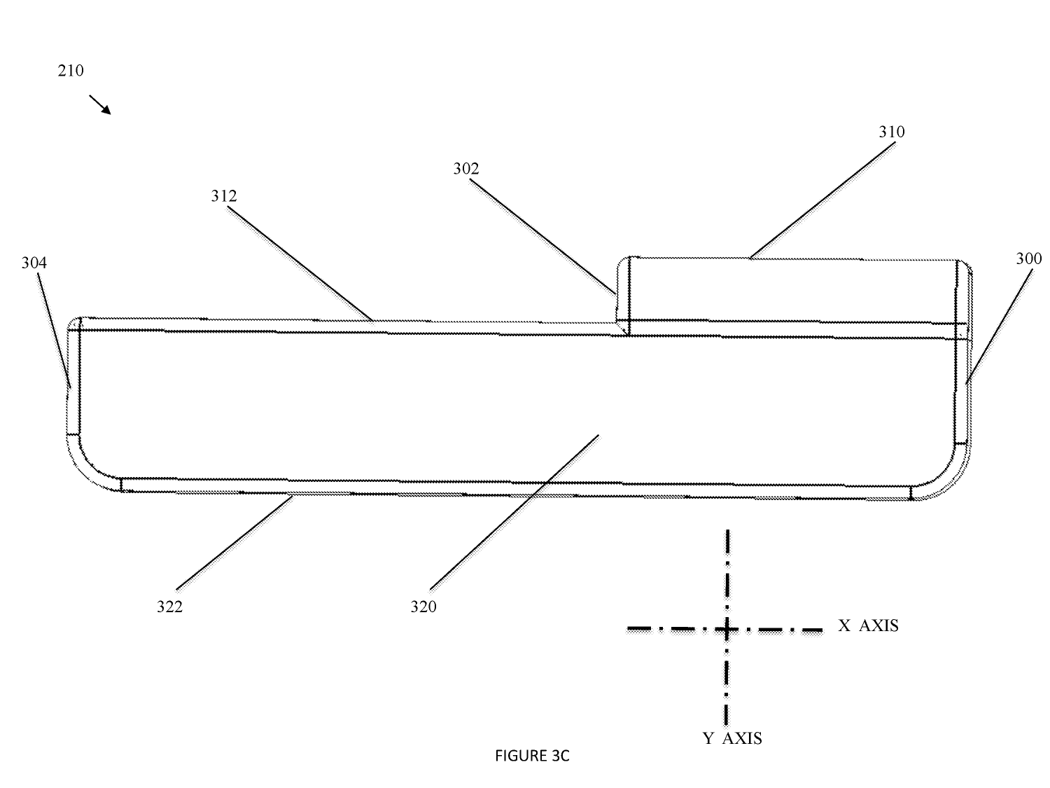

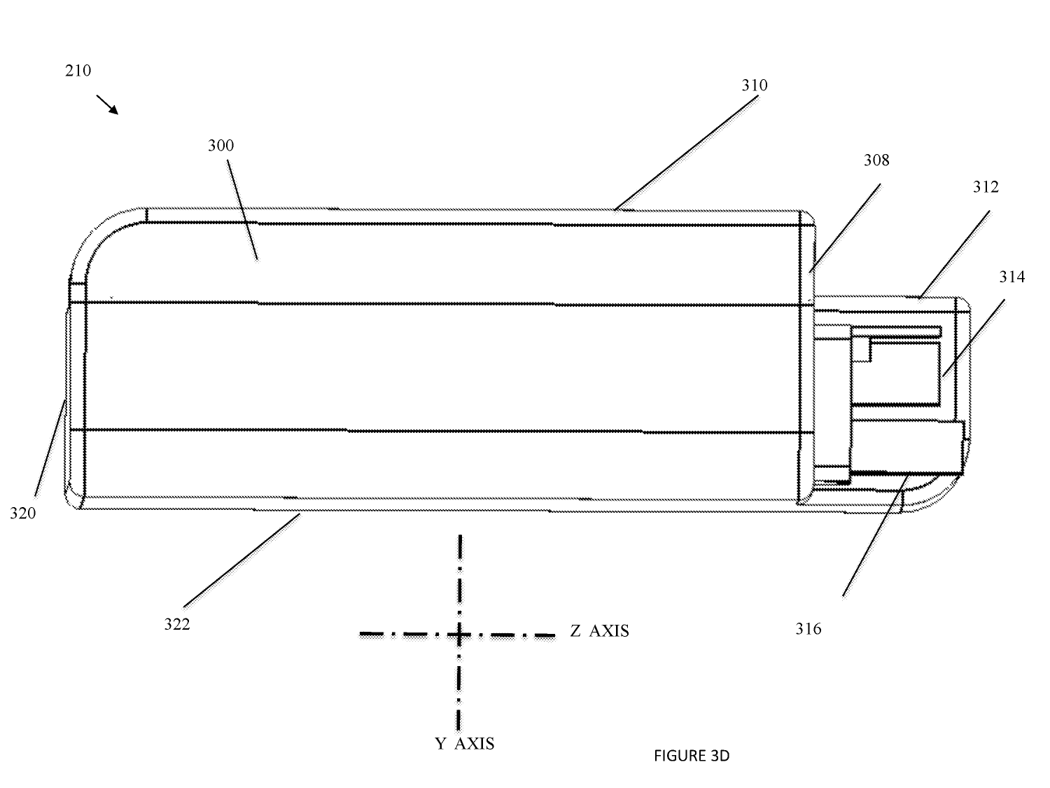

Referring now generally to the Figures and particularly to FIG. 3A, FIG. 3A is a perspective back view of the first battery module 210 and showing optional keyed features. The first battery module 210 forms a first external side surface 300, a second external surface 302 and a third external side surface 304 that are each substantively planar and parallel to each other.

The first battery module 210 additionally forms a first external back surface 306 and a second external back surface 308 that are each substantively planar and parallel to each other and further that both the first external back surface 306 and the second external back surface 308 are each orthogonal to the planar external side surfaces 300, 302 & 304 of the first battery module 210. It is understood that the first external front surface 306 is more distal from a front side of the first battery module 210 in comparison with the position of the second external front surface 308 and that the second external front surface 308 is more proximate to the same front side of the first battery module 210 in comparison with the position of the first external front surface 306.

The first battery module 210 yet additionally forms a first external top surface 310 and a second external top surface 312 that are each substantively planar and parallel to each other and further that both the first external top surface 310 and the second external back surface 312 are each orthogonal to (a.) the planar external side surfaces 300, 302 & 304 of the first battery module 210; and (b.) the planar external front surfaces 306 & 308. It is also understood that the first external top surface 310 is more distal from a bottom side of the first battery module 210 in comparison with the position of the second external top surface 312 and that the second external top surface 312 is more proximate to the same bottom side of the first battery module 210 in comparison with the position of the first external top surface 310.

The first battery module 210 additionally forms three keyed insertion features 314, 316 & 318 that extend from the second external back surface 308 and away from the front side of the first battery module 210. A keyed upper insertion feature 314 is positioned above a first keyed lower insertion feature 316 and a second keyed lower insertion feature 318.

Referring now generally to the Figures and particularly to FIG. 3B, FIG. 3B is a detailed top plan view of the first battery module 210 and showing optional keyed features 300-318 from a downward looking point of view. For the purposes of clarity of explanation a Z-axis of depth and an orthogonal X-axis of width is presented in FIG. 3B, wherein the Z-axis of depth extends between and is orthogonal to the substantively planar front side surface 320 of the first battery module 210 and toward the substantively planar back side surface 306 of the first battery module 210; and the X-axis of width extends between and is orthogonal to the substantively planar first external side surface 300 of the first battery module 210 and the substantively planar third external side surface 304 of the first battery module 210.

Referring now generally to the Figures and particularly to FIG. 3C, FIG. 3C is a detailed front plan view of the first battery module 210 showing and showing certain optional keyed surfaces 300-306, 310 & 312 and additional optional keyed surfaces 320 & 322 of the first battery module 210. An external front surface 320 defines the front side of the first battery module 210 and an external bottom surface 322 defines the bottom side of the first battery module 210.

For the purposes of clarity of explanation a Y-axis of height and the orthogonal X-axis of width is presented in FIG. 3C, wherein the Y-axis of height extends between and is orthogonal to the substantively planar bottom surface 322 of the first battery module 210 and toward the substantively planar top surfaces 310 & 312 surface 306 of the first battery module 210; and the X-axis of width extends between and is orthogonal to the substantively planar first external side surface 300 of the first battery module 210 and the substantively planar third external side surface 304 of the first battery module 210. It is understood that the Y-axis, the X-axis and the Z-axis are each mutually orthogonal to the other two axes.

Referring now generally to the Figures and particularly to FIG. 3D, FIG. 3D is a detailed right side plan view of the first battery module 210 and showing certain optional keyed surfaces 300, 308, 310, 320 & 322 and two keyed insertion features 314 & 316 (wherein the first keyed lower insertion feature 316 blocks visibility of the second keyed lower insertion feature 316 318).

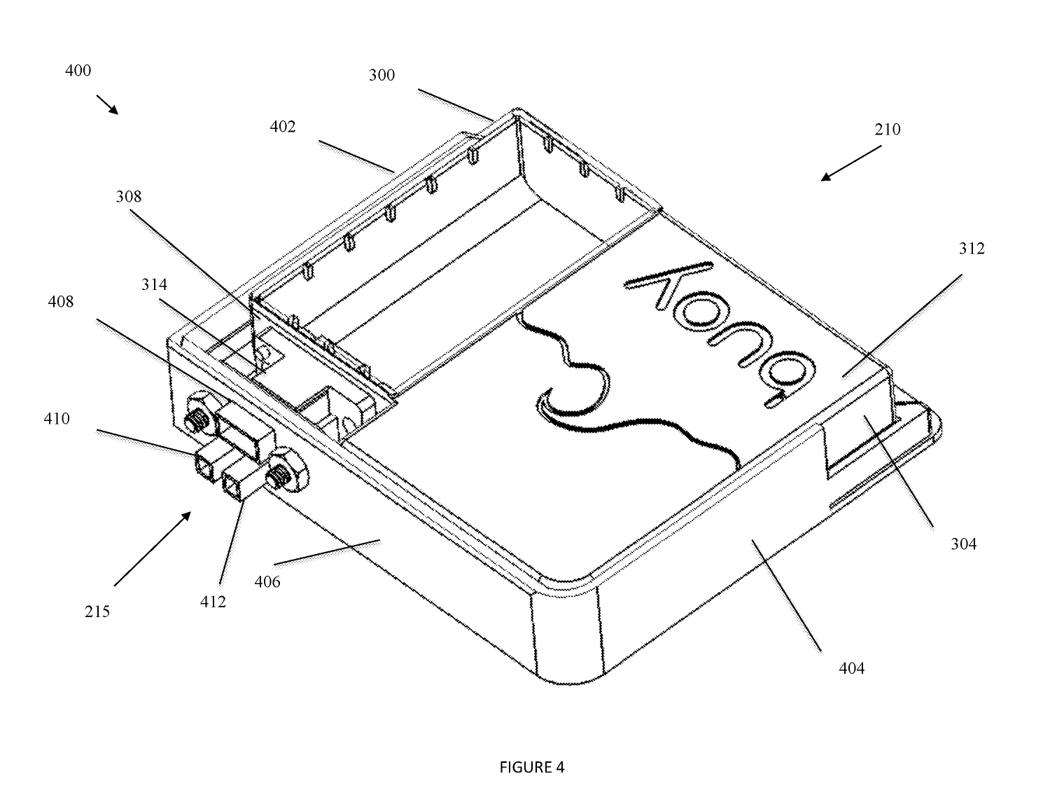

Referring now generally to the Figures and particularly to FIG. 4, FIG. 4 is a cut away perspective top view of the first battery module 210 inserted into a receiver 400 of the housing 202 and showing the receiver 400 presenting keyed receiver side walls 402-406 matching the optional keyed battery module receiver features 408-412. A first receiver side wall 402 and a second receiver side wall 404 preferably substantively planar and parallel to each and sufficiently displaced along the X-axis to permit insertion of the first battery module 210 within the receiver 400.

A back receiver wall 406 is preferably substantively planar and orthogonal to both the first receiver side wall 402 and the second receiver side wall 404. The back receiver wall 406 is coupled with the internal system connector 215, wherein the internal system connector 215 presents optional keyed battery module receiver features 408-412. A keyed top receiver feature 408 is sized and shaped to accept at least partial insertion of the receive the keyed upper insertion feature 314 of the first battery module 210; a first keyed lower receiver feature 410 is sized and shaped to accept at least partial insertion of the first keyed lower insertion feature 316 of the first battery module 210; and a second keyed lower receiver feature 412 is sized and shaped to accept at least partial insertion of the second keyed lower insertion feature 318 of the first battery module 210.

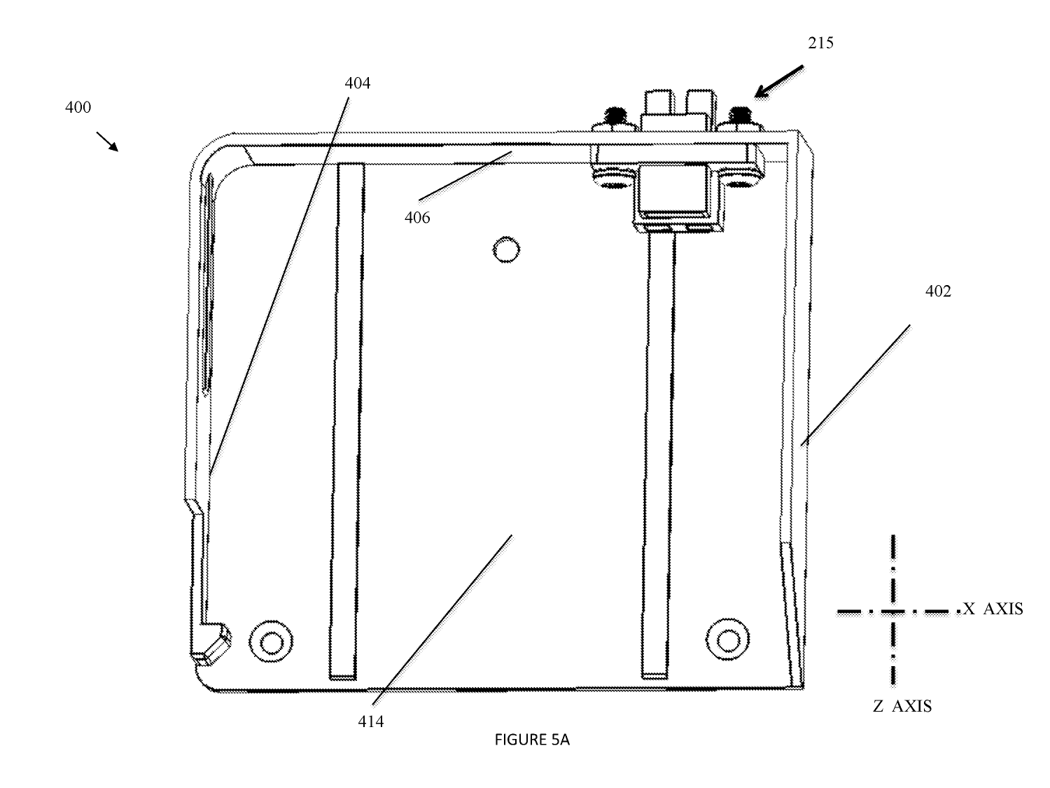

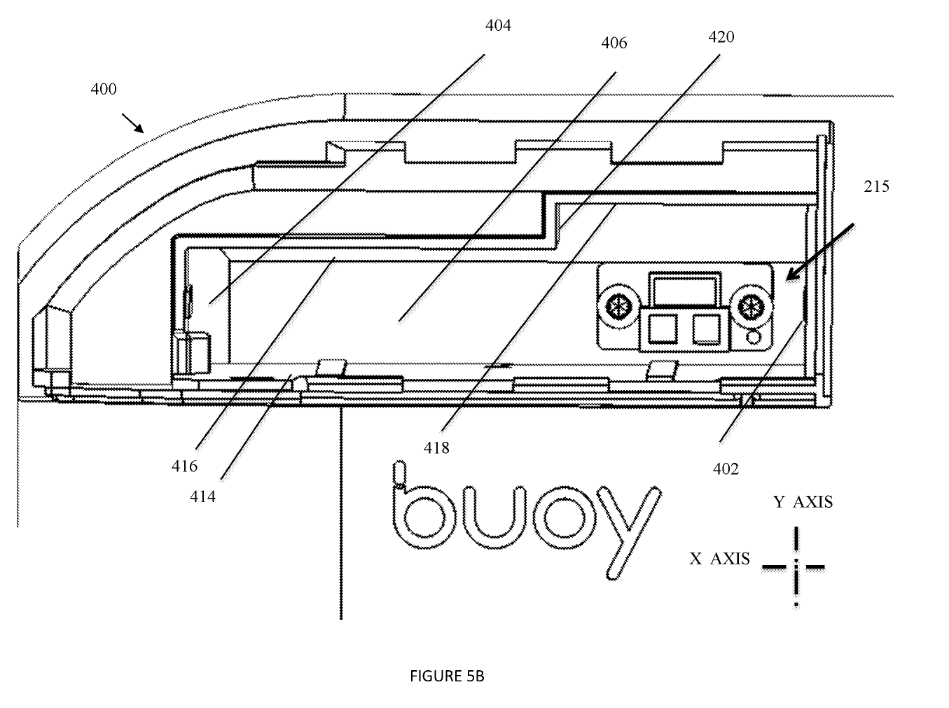

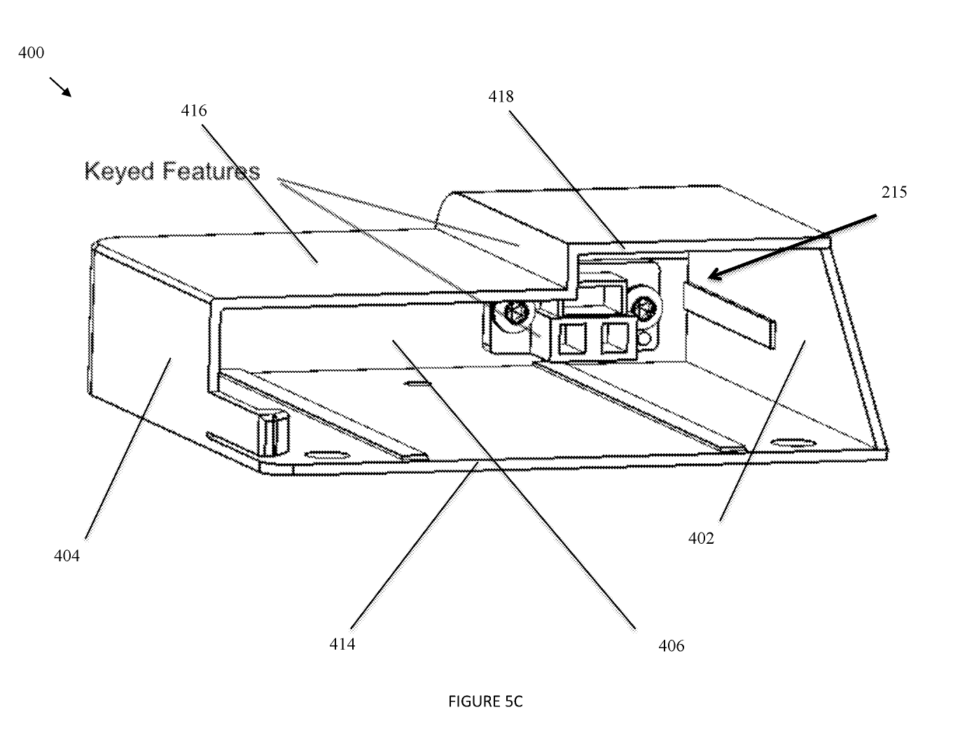

Referring now generally to the Figures and particularly to FIG. 5A, FIG. 5A is a detailed top view of the receiver 400 showing the internal system connector 215, the receiver side walls 402 & 404, the receiver back wall 406 and a receiver bottom wall 414 that are in combination sized, shaped and positioned to accept at least partial simultaneous insertion of the keyed battery module surfaces 300-312, 320 & 322 and the keyed battery module insertion features 314, 316 & 318 of the first battery module 210.

For the purposes of clarity of explanation the Z-axis of depth and the orthogonal X-axis of width is presented in FIG. 5A, wherein the Z-axis is orthogonal to the substantively planar receiver back wall 406 of the receiver 400, and the Z-axis is also parallel to both of the substantively planar receiver side walls 402 & 404 of the receiver 400. And the X-axis of width extends between and is orthogonal to the substantively planar first receiver side wall 402 of the receiver 400 and the substantively planar second receiver side wall 404.

Referring now generally to the Figures and particularly to FIG. 5B, FIG. 5B is a detailed front plan view of the receiver 400 showing the internal system connector 215, the receiver side walls 402 & 404, the receiver back wall 406, the receiver bottom wall 414, a first receiver top wall 416, a second receiver top wall 418 and a third side wall 420.

For the purposes of clarity of explanation the Y-axis of height and the orthogonal X-axis of width is presented in FIG. 5B, wherein the Y-axis of height extends between and is orthogonal to the substantively planar bottom wall 414 of the receiver 400 and the substantively planar top walls 416 & 418 of the receiver 400, and the X-axis of width extends between and is orthogonal to the substantively planar first side wall 402 of the receiver 400 and the substantively planar second side wall 404 of the receiver 400.

The receiver bottom wall 414, a first receiver top wall 416 and a second receiver top wall are each preferably substantively planar and mutually parallel; the receiver bottom wall 414, the first receiver top wall 416 and the second receiver top wall 418 are each preferably substantively orthogonal to the receiver side walls 402, 404 & 420 and the receiver back wall 406. It is understood that the receiver bottom wall 414, the first receiver top wall 416 and the second receiver top wall 418 are sufficiently displaced along the Y-axis and sized, shaped and positioned to accept at least partial simultaneous insertion of (a.) the battery module external side surfaces 300-306, (b.) the battery module external top surfaces 310 & 312, (c.) the battery module external bottom surface 322, and (d.) the battery module insertion features 314-318 into respective individual keyed receiver features 408-412.

The third side wall 420, the first receiver side wall 402 and the second receiver side wall 404 are preferably substantively planar and mutually parallel. It is also understood that third side wall 420, the first receiver side wall 402 and the second receiver side wall 404 are sufficiently displaced along the X-axis and sized, shaped and positioned to accept at least partial simultaneous insertion of (a.) the battery module external side surfaces 300-306, (b.) the battery module external top surfaces 310 & 312, (c.) the battery module external bottom surface 322, and (d.) the battery module insertion features 314-318 into respective individual keyed receiver features 408-412.

Referring now generally to the Figures and particularly to FIG. 5C, FIG. 5C is a detailed perspective front view of the receiver of 400 showing the internal system connector 215, the receiver side walls 402 & 404, the receiver back wall 406, the bottom receiver wall 414, the first receiver top wall 416 and the second receiver top wall 418.

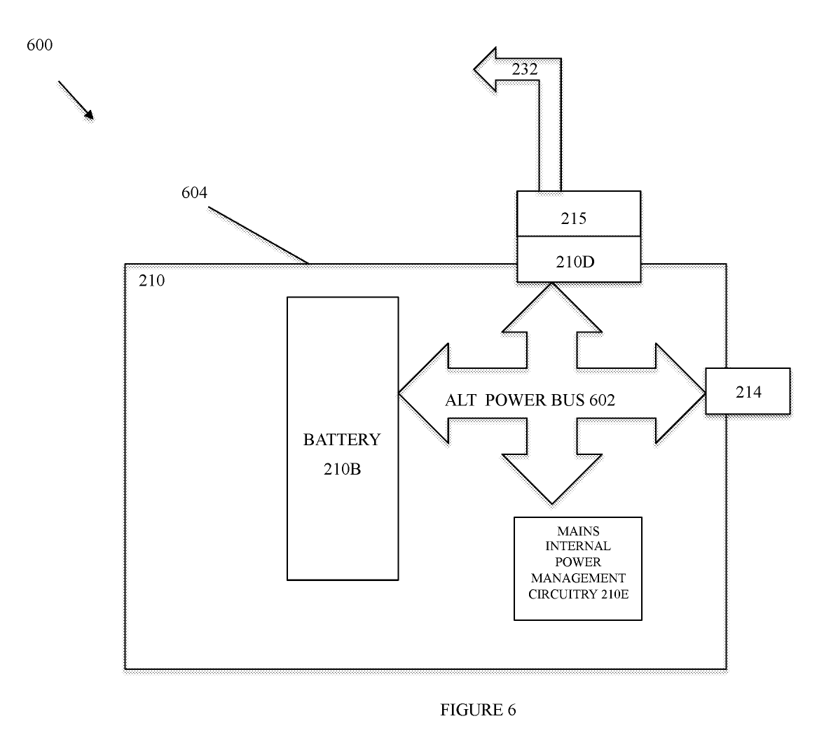

FIG. 6 is a block diagram of an alternate preferred embodiment of the detachable battery module 600 (hereinafter, “the second battery module” 600) that includes a first module alternate power and communications bus 602 configured to receive electrical power directly through an external connector 214 and enable distribution of electrical power received from a standard mains power network as directed by the module power management circuitry 210E. The first alternate power and communications bus 602 of the second battery module 600 is adapted and configured to receive electrical power directly from the external module connector 214 and delivers the received electrical power to the module power management circuitry 210E, the module battery 210B and the intermediate power and communications bus 232 via the module connector 210D as directed and rectified by the module power management circuitry 210E. The first alternate module power and communications bus 602 optionally additionally enables bi-directional communications between the module power management circuitry 210E and the control board 212 via the intermediate power and communications bus 232 and the internal connector 215, whereby battery status and battery module 210 control information can be exchanged between the module power management circuitry 210E and the control board 212 via the intermediate power and communications bus 232 and the internal connector 215.

A second thermoplastic shell 604 encloses the first alternate module power and communications bus 602, the module battery 210B, and the module power management circuitry 210E. The module connector 210D and the external connector 214 are each coupled with and each extend through the second thermoplastic shell 604.

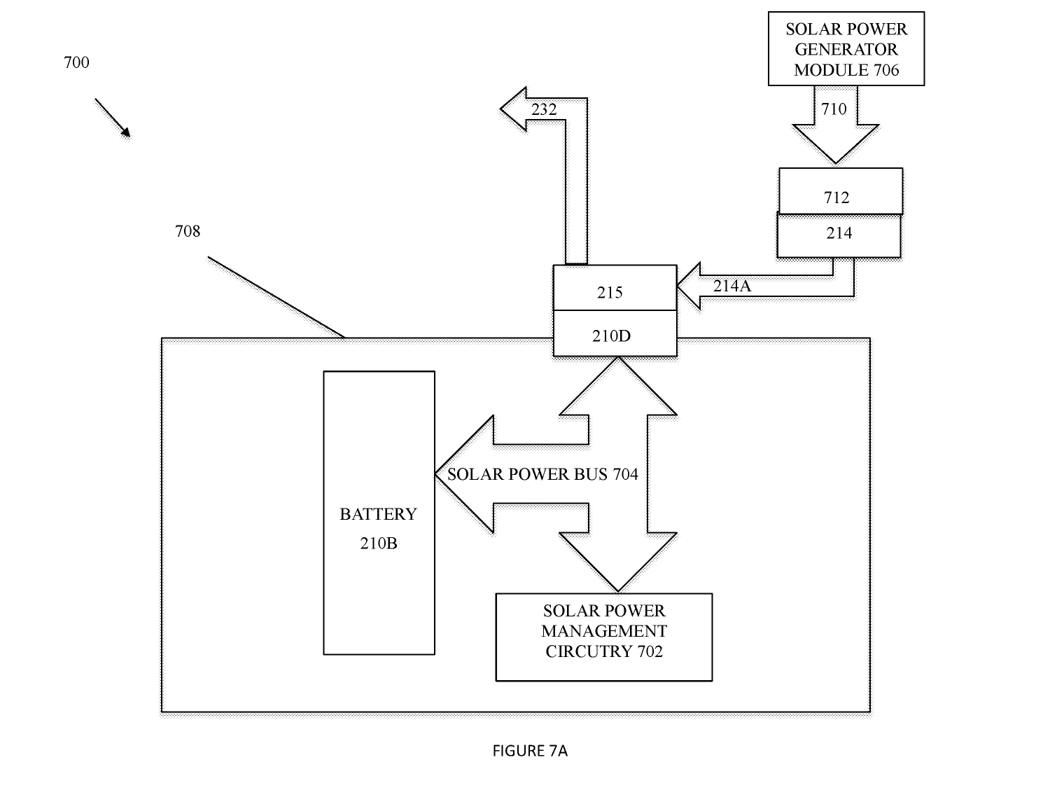

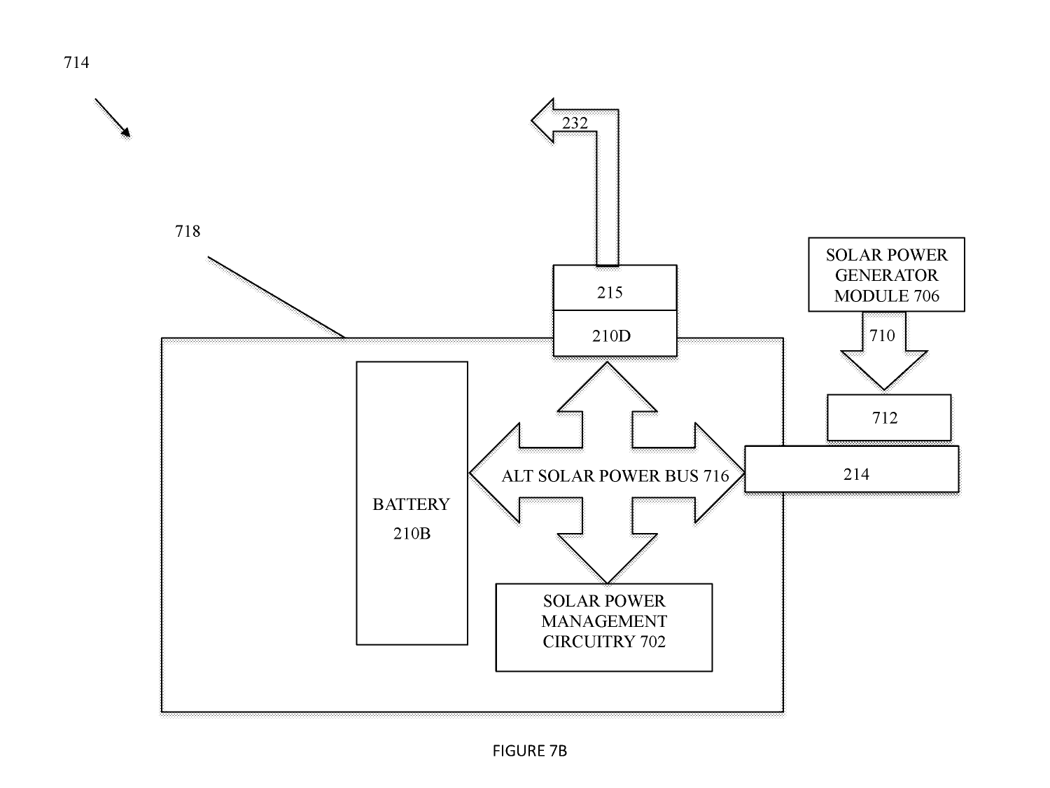

FIG. 7A is a block diagram of a still alternate preferred embodiment of the detachable battery module 700 (hereinafter, “the third battery module” 700″) that includes a solar power management circuit 702 that is configured by means of a solar power and communications bus 716 to manage distribution of electrical power received from a solar energy generator module 706. The solar power and communications bus 704 of the third battery module 700 enables receipt of electrical power from the module connector 210D and delivers the received electrical power to the solar power management circuit 702, the module battery 210B and the intermediate power and the communications bus 232 via the module connector 210D as directed and rectified by the solar power management circuit 702. The solar power and communications bus 704 optionally additionally enables bi-directional communications between the solar power management circuit 702 and the control board 212 via the intermediate power and communications bus 232 whereby battery status of the module battery 210B and commands can be exchanged between the solar power management circuit 702 and the control board 212 via the intermediate power and communications bus 232.

A third thermoplastic shell 708 encloses the solar power management circuit 702 the solar power and communications bus 716 and the module battery 210B. The module connector 210D is coupled with and extends through the third thermoplastic shell 708.

The solar power module 706 is electrically coupled via a solar energy bus 710 to a solar energy connector 712. The solar energy connector 712 is configured and adapted to be detachably electrically and mechanically coupled with the external connector 214; the solar energy connector 712 transfers electrical power to the external connector 214. Optionally the solar energy connector 712 may be configured and adapted to transfer information-bearing signals commands to and/or from the solar power module 706 and the solar power management circuit 702 via the external connector 214, the first power bus 214A, the internal connector 215, the module connector 210D and the solar power and communications bus 704. It is understood that the solar energy bus 710 may be configured and adapted to transfer information-bearing signals commands to and/or from the solar power module 706 and the solar energy connector 712.

FIG. 7B is a block diagram of a yet alternate preferred embodiment of the invented battery module (hereinafter, “the fourth battery module” 714) that includes an alternate solar power and communications bus 716 configured to manage distribution of electrical power received from the solar energy generator module 706 as received directly through the external connector 214.

The fourth battery module 714 includes the solar power management circuit 702 that is enabled by means of the alternate solar power and communications bus 716 to manage distribution of electrical power received from the solar energy generator module 706 via the external connector 214 and the alternate solar power and communications bus 716 with reduced or no intermediation. The alternate solar power and communications bus 716 of the fourth battery module 714 is adapted and configured to receive electrical power directly from the external connector 214 and delivers the received electrical power to the solar power management circuit 702, the module battery 210B and the intermediate power and the communications bus 232 via the module connector 210D as directed and rectified by the solar power management circuit 702. The alternate solar power and communications bus 716 optionally additionally enables bi-directional communications between the solar power management circuit 702 and the control board 212 via the module connector 210D, the intermediate power and communications bus 232 and the internal connector 215, whereby battery status of the module battery 210B and commands can be exchanged between the solar power management circuit 702 and the control board 212 via the intermediate power and communications bus 232.

A fourth thermoplastic shell 718 encloses the alternate solar module power and communications bus 716, the module battery 210B, and the solar power management circuitry 702. The module connector 210D and the external connector 214 are each coupled with and each extend through the fourth thermoplastic shell 718.

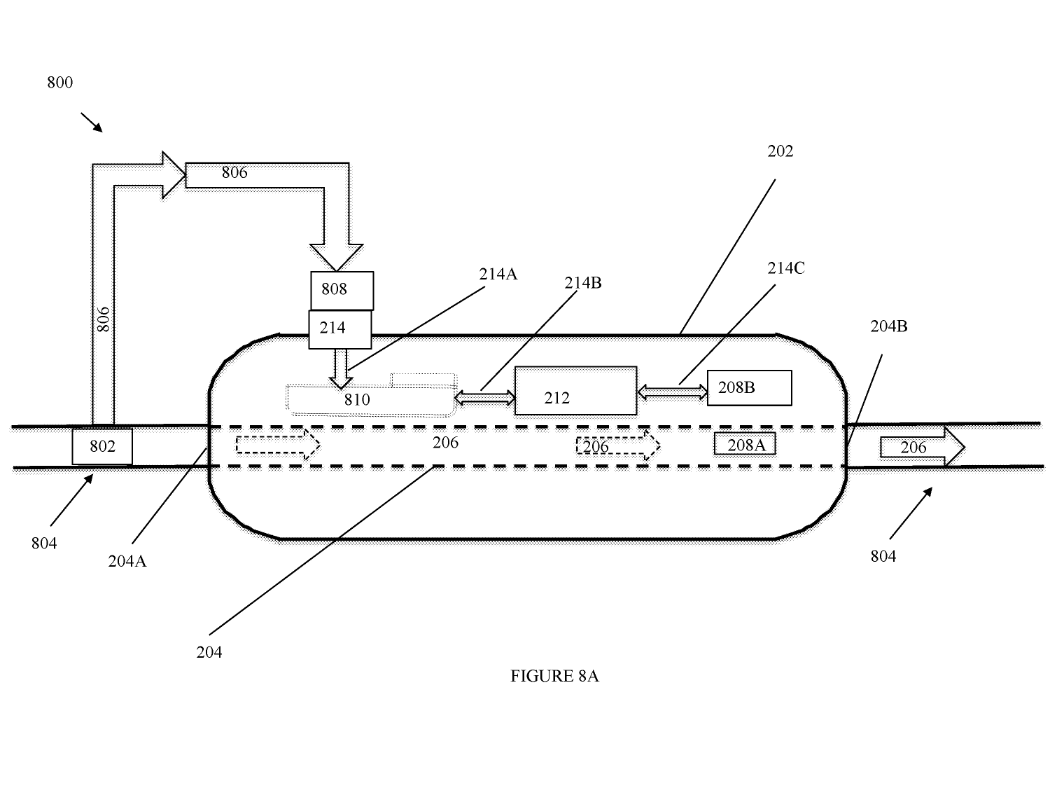

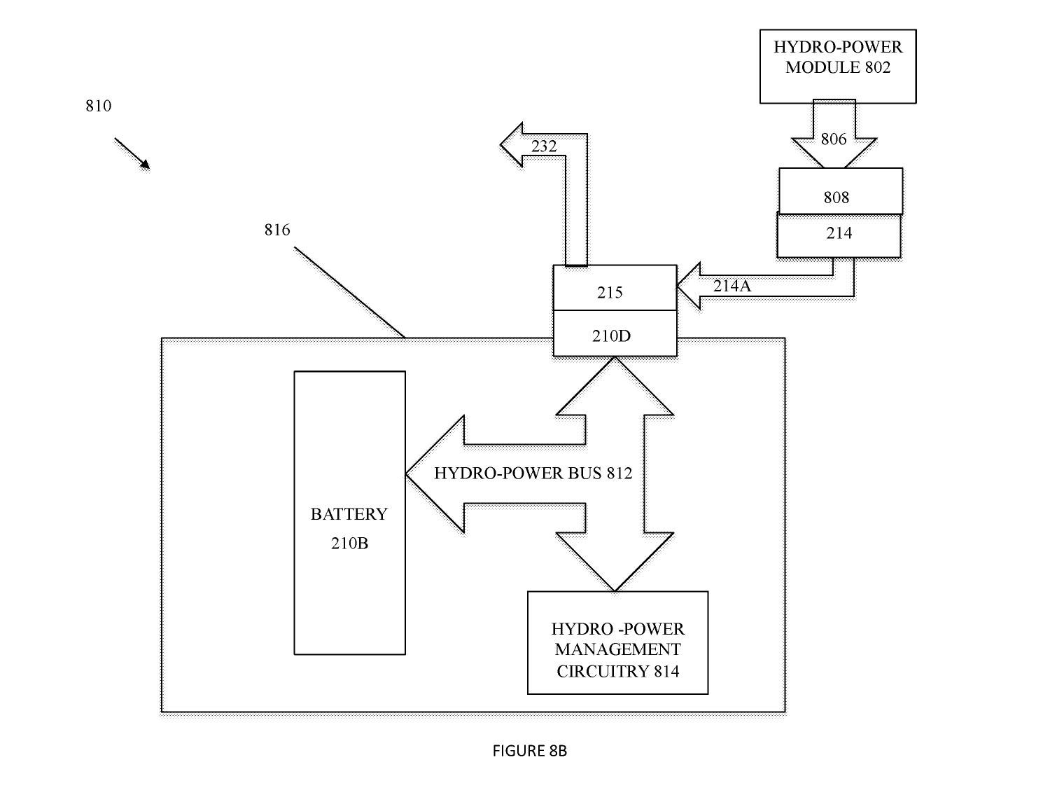

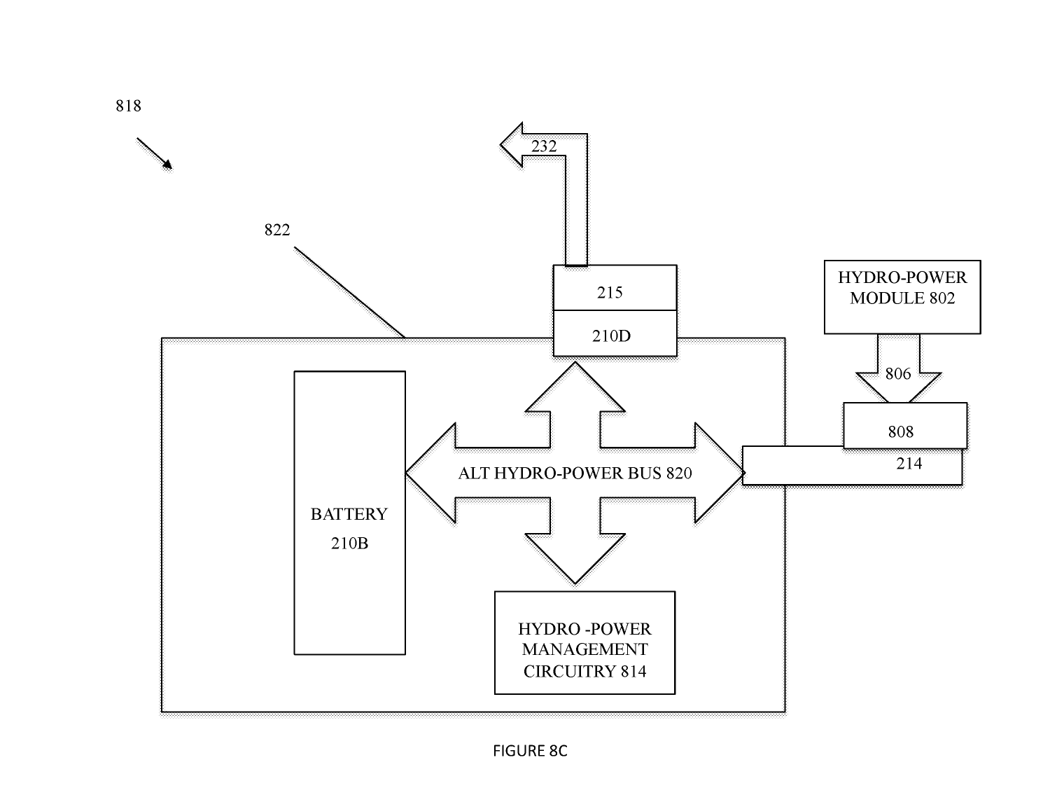

Referring now generally to the Figures and particularly to FIG. 8A, FIG. 8A is a block diagram of another alternate preferred embodiment of the present invention 800 (hereinafter, “the hydro-power system” 800) that is adapted to receive power from an in-pipe hydro-power generator module 802. It is understood that the in-pipe hydro-power generator module 802 may be, comprise or be comprised within a YOSOO™ DC Water Turbine Generator Water 12V DC 10 W Micro-hydro Water Charging Tool™ as marketed by Junchao Zhuang of Guangzhou, China.

The in-pipe hydro-power generator module 802 is preferably positioned within a plumbing piping 804 and positioned to receive mechanical force by engagement with the fluid 206 as the fluid 206 dynamically flows through the piping 804. A hydro-energy power and communications bus 806 is electrically and optionally communicatively coupled with both the in-pipe hydro-power generator module 802 and a hydro-power energy connector 808.

The hydro-power energy connector 808 is configured and adapted to be detachably electrically and mechanically coupled with the external connector 214; the hydro-power energy connector 808 transfers electrical power an invented hydro-power battery module 810.

Referring now generally to the Figures and particularly to FIG. 8A and FIG. 8B, the hydro-power energy connector 808 may optionally be configured and adapted to transfer information-bearing signals commands to and/or from the hydro-power module 802 and the hydro-power battery module 810 via the external connector 214, the first power bus 214A, the internal connector 215, the module connector 210D and a hydro-power and communications bus 812 of the hydro-power battery module 810. It is understood that the hydro-power power and communications bus 812 may be configured and adapted to transfer information-bearing signals commands to and/or from a the hydro-power management circuit 814 of the hydro-power module 802 and hydro-power energy connector 808.

Referring now generally to the Figures and particularly to FIG. 8B, FIG. 8B is a block diagram of the detachably attachable hydro-powered battery module 810 that includes the module battery 210E, the module connector 210D, the hydro-power power and communications bus 812, and the hydro-power management circuit 814. The hydro-power management circuit 814 is preferably configured and adapted to manage distribution of electrical power received from the in-pipe hydro-power generator module 802 by means of the hydro-power power and communications bus 812.

A fifth thermoplastic shell 816 encloses the hydro-power management circuit 814, the hydro-power power and communications bus 812 and the module battery 210B. The module connector 210D is coupled with and extends through the fifth thermoplastic shell 816.

Referring now generally to the Figures and particularly to FIG. 8C, FIG. 8C is a block diagram of an additional alternate preferred embodiment of the present invention (hereinafter, “the second hydro-power battery module” 818) that includes an alternate hydro-power power and communications bus 820 that is configured and adapted to manage distribution of electrical power received from the in-pipe hydro-power generator module 802 with reduced intermediation.

The second hydro-power battery module 818 includes the module battery 210E, the module connector 210D, the external connector 214, the alternate hydro-power power and communications bus 820, and the hydro-power management circuit 814. The hydro-power management circuit 814 is preferably configured and adapted to manage distribution of electrical power received from the in-pipe hydro-power generator module 802 by means of the alternate hydro-power power and communications bus 820.

The hydro-power management circuit 814 is enabled by means of the alternate hydro-power power and communications bus 820 to manage distribution of electrical power received from the hydro-power module 802 via the external connector 214 and the alternate hydro-power power and communications bus 820 with reduced or no intermediation.

The alternate hydro-power power and communications bus 820 of the second hydro-power battery module 818 is adapted and configured to receive electrical power directly from the external connector 214 and delivers the received electrical power to the hydro-power management circuit 814, the module battery 210B and the intermediate power and the communications bus 232 via the module connector 210D as directed and rectified by the hydro-power management circuit 814. The alternate hydro-power power and communications bus 820 optionally additionally enables bi-directional communications between the hydro-power management circuit 814 and the control board 212 via the module connector 210D, the intermediate power and communications bus 232 and the internal connector 215, whereby battery status of the module battery 210B and commands can be exchanged between the hydro-power management circuit 814 and the control board 212 via the intermediate power and communications bus 232.

A sixth thermoplastic shell 822 encloses the alternate hydro-power power and communications bus 820, the module battery 210B, and the hydro-power management circuitry 814. The module connector 210D and the external connector 214 are each coupled with and each extend through the sixth thermoplastic shell 822.

As generally noted above, is understood that a common electrical ground is preferably shared by the buses 214A, 214, 210C, 704, 812 & 820 and the connectors 210D, 214, 215, 712 and 808 by inclusion of a ground wiring (not shown) or other suitable electrical grounding structures known in the art.

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Finally, terms of degree such as “substantially”, “about” and “approximately” as used herein mean a reasonable amount of deviation of the modified term such that the end result is not significantly changed.

While selected embodiments have been chosen to illustrate the invented system, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment, it is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. An apparatus for coupling with a fluid flow channel and communicatively coupled with an electronic communications network, the apparatus comprising:
a) a flow detector, the flow detector sensing fluid flow of the channel and generating measurement data;
b) a communications interface communicatively coupled with the flow detector and receiving measurement data from the flow detector, the communications interface communicatively coupled with the electronic communications network and transmitting information derived from measurement data received from the flow detector; and
c) a detachable battery module detachably coupled with the flow detector and the communications interface, the detachable battery module providing electrical power to the flow detector and the communications interface.

2. The apparatus of claim 1, further comprising a controller communicatively coupled with the flow detector and the communications interface, the controller receiving fluid flow measurements from the flow detector and transmitting information derived from the measurement data received from the flow detector to the communications interface, and the controller detachably coupled with and receiving electrical power from the detachable battery module.

3. The apparatus of claim 2, further comprising a housing, the housing coupled with and enclosing the flow detector, the controller, and the communications interface, and the housing detachably coupled with the detachable battery module.

4. The apparatus of claim 2, further comprising an external power source link, the external power source link coupled with and providing electrical power to the flow detector, the controller, and the communications interface, wherein the electrical power delivered by the external power source link is sourced externally from the apparatus.

5. The apparatus of claim 2, wherein the detachable battery module is coupled with and receives electrical power from an external power source.

6. The apparatus of claim 5, the detachable battery module further comprising an energy pathway and an energy storage cell, the energy pathway coupled with the energy storage cell and detachably coupled the external power source, and the energy pathway delivering electrical power received from the external power source through the detachable battery module to the flow detector, the controller, and the communications interface when electrical power is not received from the external power source.

7. The apparatus of claim 6, wherein the energy pathway delivers power received from the external power source to the energy storage cell.

8. The apparatus of claim 7, wherein the electrical battery module further comprises a power management circuit, the power management circuit disposed within the energy pathway and between the external power source and the energy storage cell.

9. The apparatus of claim 8, wherein the external power source conforms to a mains electrical power standard and the power management circuit is configured and positioned to manage distribution of electrical power received from the external power source prior and to output the conditioned electrical power to the storage battery cell, the flow detector, the controller and the communications interface.

10. The apparatus of claim 8, wherein the external power source comprises a solar energy generator and the power management circuit is configured and positioned to manage distribution of electrical power received from the external power source prior and to output the conditioned electrical power to the storage battery cell, the flow detector, the controller and the communications interface.

11. The apparatus of claim 8, wherein the external power source comprises an in-pipe electrical power generation module and the power management circuit is configured and positioned to manage distribution of electrical power received from the in-pipe energy generation module prior and to output the conditioned electrical power to the storage battery cell, the flow detector, the controller and the communications interface.

12. The apparatus of claim 8, wherein the detachable battery module comprises at least one keyed feature to permit only properly aligned detachable coupling of the detachable battery module with the controller.

13. The apparatus of claim 12, wherein the at least one keyed feature comprises an electrical power connector.

14. The apparatus of claim 3, wherein the battery module comprises at least one keyed feature to permit only properly aligned detachable placement of the detachable battery with the housing.

15. The apparatus of claim 14, wherein the at least one keyed feature comprises an electrical power connector.

16. The apparatus of claim 3, wherein the detachable battery module is enclosed within a shaped sealant structure, and the shaped sealant structure shaped to permit only properly aligned detachable placement of the detachable battery module with the housing.

17. The apparatus of claim 16, wherein the detachable battery module further comprises at least one keyed feature to permit only properly aligned detachable placement of the detachable battery module with the housing.

18. The apparatus of claim 17, wherein the at least one keyed feature comprises an electrical power connector.

19. The apparatus of claim 16, wherein the housing comprises a recessed portion and the detachable battery shaped sealant structure comprises a battery projection that in combination permit only properly aligned detachable placement of the detachable battery module with the housing.

20. The apparatus of claim 19, wherein the battery projection positions an electrical power connector, wherein the electrical power connector is operationally coupled with the controller when the detachable battery module is properly aligned and emplaced with the housing.

21. The apparatus of claim 20, wherein the detachable battery module is enclosed within a shaped sealant structure, and the shaped sealant structure shaped to permit only properly aligned detachable placement of the detachable battery module with the housing, and the detachable battery module comprises an electrical power connector, wherein the electrical power connector is operationally coupled with the electrical power pathway when the detachable battery module is properly aligned and emplaced with the housing.

22. The apparatus of claim 1, wherein the measurement data indicates when fluid flow in the fluid flow channel exceeds a fluid flow threshold value.

23. The apparatus of claim 1, wherein the measurement data indicates a measured value of fluid flow of the fluid flow channel.

24. An apparatus comprising:
means to detect fluid flow through a channel;
means to report fluid flow detection; and
a detachable battery module detachably coupled with the means to detect and the means to report, the detachable battery module providing electrical power to the means to detect fluid and the means to report.
